(19) United States
(12) Patent Application Publication
(10) Pub. No.: US 2006/0154176 A1
(43) Pub. Date: Jul. 13, 2006

(54) Photoresist composition, method of forming a photoresist pattern and method of forming a protection layer in a semiconductor device using the photoresist composition

(76) Inventors: Seok-Bong Park, Gyeonggi-do (KR); Won-Mi Kim, Gyeonggi-do (KR); Jae-Hyun Kim, Incheon (KR)

Correspondence Address: MARGER JOHNSON & MCCOLLOM, P.C., 210 SW MORRISON STREET, SUITE 400, PORTLAND, OR, 97204, US

(21) Appl. No.: 11/331,305

(22) Filed: Jan. 11, 2006

(30) Foreign Application Priority Data
Jan. 13, 2005 (KR) 2005-03161

(51) Int. Cl. G03C 1/76

(52) U.S. Cl. 430/270.1

(57) ABSTRACT

A photoresist composition comprising a hydrogen-bonding compound and a thermosetting resin is provided. A method of forming a photoresist pattern is also provided. The method comprises forming a photoresist film on an object by coating the object with a photoresist composition including a hydrogen-bonding compound and a thermosetting resin. Then, the photoresist film is partially removed to form the photoresist pattern.

### CROSS REFERENCE TO RELATED APPLICATIONS

This application claims priority under 35 U.S.C. § 119 to Korean Patent Application No. 2005-03161 filed on Jan. 13, 2005, the contents of which are herein incorporated by reference in their entirety.

### BACKGROUND OF THE INVENTION

1. Field of the Invention

Embodiments of the present invention relate to a photoresist composition, a method of forming a photoresist pattern, and a method of forming a protection layer using the photoresist composition.

2. Description of the Related Art

Semiconductor devices having high integration degrees and rapid response speeds are desired as information processing apparatuses have been developed. Hence, the technology of manufacturing the semiconductor devices has been developed to improve integration degrees, reliability and response speeds of the semiconductor devices.

Semiconductor memory devices are largely divided into volatile memory devices and nonvolatile memory devices. The volatile memory device, such as a static random-access memory (SRAM) or a dynamic random-access memory (DRAM), loses data stored therein when power is turned off. The nonvolatile memory device such as a read-only memory (ROM), an erasable and programmable ROM (EPROM) or an electrically erasable and programmable ROM (EEPROM) maintains data stored therein even after power is turned off.

The DRAM or the nonvolatile memory device has a capacitor that stores data temporarily or permanently, respectively. A data maintenance ability of the DRAM or the nonvolatile memory device depends on a capacitance of the capacitor.

As the semiconductor memory devices having high integration are required, the dimensions of the capacitor have become smaller, and the capacitance of the capacitor has been reduced. When a capacitor in a memory cell does not have a sufficiently large capacitance, the capacitor is affected by external factors, such as radioactive rays, to lose data easily, and thus, a read error is frequently generated. Furthermore, when the semiconductor memory devices are physically impacted in a packaging process, an operational defect is generated or the capacitance of the capacitor is changed, so that reliabilities of the semiconductor memory devices are deteriorated. Therefore, in order to protect the semiconductor memory devices from the external influences or the physical impacts, a finished semiconductor chip is connected to a lid frame by a wire, and then the semiconductor chip is packaged using a molding protection layer. An epoxy resin has been conventionally used for forming the molding protection layer. The epoxy resin properly absorbs an external physical impact, but the epoxy resin does not effectively prevent penetration of the radioactive rays or alpha particles.

Currently, a passivation layer having a predetermined thickness is formed under the molding protection layer. The passivation layer is generally formed using phosphor silicate glass (PSG) to prevent the semiconductor chip from being corroded by chemicals. However, when a single passivation layer formed using PSG and the like is employed for a chip carrier package to protect a semiconductor device, some problems are generated.

A metal such as aluminum is easily corroded by chemicals. When a pad or an extended portion of the pad includes aluminum, the pad or the extended portion of the pad is severely damaged by a slight contact with chemicals. The single passivation layer formed using the PSG does not effectively protect a bonding pad including aluminum from corrosion. Furthermore, when the passivation layer has a fine crack, moisture infiltrates into the passivation layer to form a corrosive compound, such as phosphoric acid. The corrosive compound damages a metal line (e.g., an aluminum line) positioned under the passivation layer.

To solve the above problems, methods of forming an additional passivation layer or a buffer layer on a substrate using polyimide or a metal are disclosed in U.S. Pat. No. 4,733,289 issued to Tsurumaru, and U.S. Pat. No. 4,827,326 issued to Altman, et al. In the prior art methods, the additional passivation layer or the buffer layer is formed using a non-photosensitive polyimide, so that an additional photoresist film is required for patterning the polyimide layer. In particular, after forming the photoresist film on the polyimide layer, the photoresist film is patterned by a photolithography process to form a photoresist pattern, and then the polyimide layer is patterned using the photoresist pattern as an etching mask.

Methods of forming a buffer layer using a photosensitive polyimide resin are disclosed in U.S. Pat. No. 5,194,928 issued to Cronin, et al. and U.S. Pat. No. 5,599,655 issued to Ngo. In the methods, a photolithography process is performed directly on the buffer layer formed using the photosensitive polyimide resin.

The photosensitive polyimide resin has an average molecular weight substantially smaller than that of a conventional polyimide resin. When a protection layer is formed using the photosensitive polyimide resin, damage or loss of the photosensitive polyimide resin is generated in a developing process and a subsequent etching process. Accordingly, the finished protection layer has a very small thickness and thus does not effectively protect underlying structures or semiconductor devices.

To compensate for the loss of the photosensitive polyimide resin, a buffer layer having a sufficiently larger thickness has been suggested. However, an excessively large amount of photosensitive polyimide resin and a strong intensity of exposure energy are needed, which is economically undesirable. Therefore, a photoresist composition for forming a protection layer in a semiconductor device that prevents damage or loss of the protection layer is needed.

### SUMMARY

Embodiments of the present invention provide a photoresist composition that prevents loss of a protection layer in a developing process. Other embodiments of the present invention provide a method of forming a photoresist pattern using the photoresist composition. Further embodiments of the present invention provide a method of forming a protection layer in a semiconductor device using the photoresist composition.

A photoresist composition is provided. The photoresist composition comprises a hydrogen-bonding compound and a thermosetting resin. Examples of the hydrogen-bonding compound may include an oxygen-containing compound, a nitrogen-containing compound, a fluorine-containing compound or combinations thereof.

Examples of the nitrogen-containing compound may include an amine compound, an amide compound, a nitrile compound or combinations thereof. Examples of the nitrogen-containing compound may include the amine compound. Examples of the amine compound may include cyclohexylamine, benzylamine, aniline, p-toluidine, p-chloroaniline, p-nitroaniline, N-methylaniline, diphenylaniline, tripropylamine, N,N-dimethylaniline, diisopropyl phenylamine or combinations thereof.

The thermosetting resin may include a polyimide resin represented by the following Chemical Formula 1, a polybenzoxazole resin represented by the following Chemical Formula 2, or a resol represented by the following Chemical Formula 3:

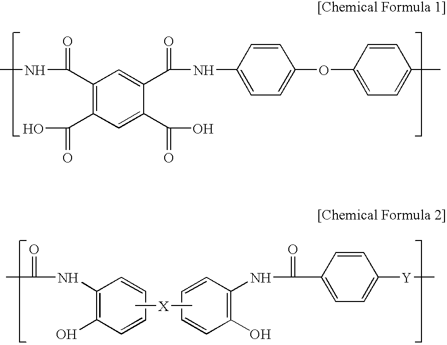

wherein X may represent 2,2-bis(3,4-dicarboxyphenyl)hexafluoropropane dianhydride, biphenyltetracarboxylic dianhydride or 3,3′,4,4′-benzophenonetetracarboxylic dianhydride, and Y may represent p-phenyl diamine, 4,4′-oxydianiline or 2,2′-bis(trifluoromethyl)-4,4′-diaminobiphenyl.

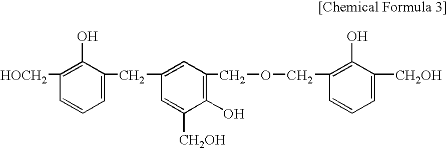

Preferably, the thermosetting resin may have a weight average molecular weight of from about 5,000 up to about 25,000. More preferably, the thermosetting resin may have a weight average molecular weight of from about 10,000 up to about 20,000.

The photoresist composition may preferably comprise from about 0.0001 up to about 2 percent by weight of the hydrogen-bonding compound, based on a total weight of the photoresist composition. More preferably, the photoresist composition may comprise from about 0.001 up to about 0.5 percent by weight of the hydrogen-bonding compound, based on a total weight of the photoresist composition.

In another embodiment, the photoresist composition comprises a hydrogen-bonding compound, a thermosetting resin and an organic solution. The photoresist composition may preferably comprise from about 0.0001 up to about 2 percent by weight of the hydrogen-bonding compound, from about 20 up to about 60 percent by weight of the thermosetting resin, and a remainder of the organic solution. More preferably, the photoresist composition may comprise from about 0.0001 up to about 2 percent by weight of the hydrogen-bonding compound, from about 20 up to about 60 percent by weight of the thermosetting resin, from about 3 up to about 10 percent by weight of the photoactive compound, and a remainder of the organic solvent.

The organic solution may comprise an organic solvent and a photoactive compound. Examples of the organic solvent may include ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol methyl ether, propylene glycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone, 4-heptanone, γ-butyrolactone, N-methyl-2-pyrrolidone or combinations thereof.

The organic solution may comprise an organic solvent, a photoactive compound and an additive. Preferably, the photoresist composition may comprise from about 0.0001 up to about 2 percent by weight of the hydrogen-bonding compound, from about 20 up to about 60 percent by weight of the thermosetting resin, from about 3 up to about 10 percent by weight of the photoactive compound, from about 0.001 up to about 5 percent by weight of the additive, and a remainder of the organic solvent.

The organic solution may comprise an organic solvent, a photoactive compound and a cross-linking agent. The photoresist composition may preferably comprise from about 0.0001 up to about 2 percent by weight of the hydrogen-bonding compound, from about 20 up to about 60 percent by weight of the thermosetting resin, from about 3 up to about 10 percent by weight of the photoactive compound, from about 0.001 up to about 10 percent by weight of the cross-linking agent, and a remainder of the organic solvent.

Preferably, the photoactive compound comprises a diazonaphthoquinone (DNQ) compound represented by the following Chemical Formula 4 or 5:

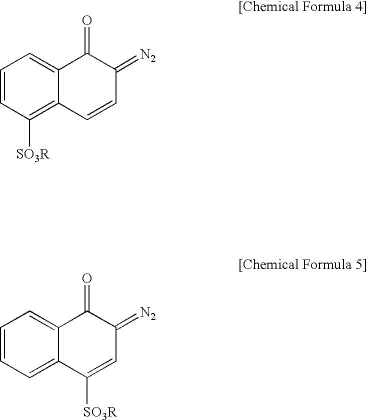

wherein R represents an aromatic group.

The additive preferably comprises a silane-based coupling agent. Examples of the cross-linking agent may include divinylbenzene, phthalic anhydride, tetrahydrophthalic anhydride, nadic methyl anhydride, chloroendic anhydride, phenol-formaldehyde, hexamethylenetetramine or combinations thereof.

A method of forming a photoresist pattern is also provided. The method comprises forming a photoresist film on an object by coating the object with a photoresist composition including a hydrogen-bonding compound and a thermosetting resin, and partially removing the photoresist film to form said photoresist pattern. Partially removing the photoresist film may comprise exposing a portion of the photoresist film to a light, and developing the photoresist film.

The photoresist film may be exposed to the light comprising a G-line ray, an I-line ray, a krypton fluoride laser, an argon fluoride laser, an electron beam or an X-ray, more preferably an I-line or a G-line ray. The photoresist film may be developed using tetramethylammonium hydroxide. Further, the method may comprise curing the photoresist film after partially removing the photoresist film. The thermosetting resin may be cross-linked in a curing of the photoresist film. And, the photoresist film may be cured at a temperature of from about 150° C. up to about 350° C.

A method of forming a protection layer in a semiconductor device can also be provided. That method comprises forming a preliminary protection layer on a substrate including a pad by coating said substrate with a photoresist composition including a hydrogen-bonding compound and a thermosetting resin, exposing a portion of the preliminary protection layer to a light, and developing the preliminary protection layer to form a protection layer exposing the pad. Before forming the preliminary protection layer, an additional protection layer may be formed on the substrate including the pad. The additional protection layer may be formed using oxide or nitride. The method may further comprise partially removing the additional protection layer to expose the pad and/or partially removing the additional protection layer using the protection layer as a mask to expose the pad. The method may also further comprise curing the protection layer.

Another method of forming a protection layer in a semiconductor device can be provided. This method comprises forming a first protection layer on a semiconductor substrate including a bonding pad, forming a second protection layer on the first protection layer by coating with a photoresist composition including a hydrogen-bonding compound and a thermosetting resin, exposing a portion of the second protection layer to a light, developing the second protection layer to form a second protection layer pattern exposing a predetermined portion of the first protection layer, and partially removing the first protection layer using the second protection layer as a mask to form a first protection layer pattern exposing the bonding pad.

Thus, loss of the protection layer may be prevented in a developing process, and the protection layer that effectively passivates underlying semiconductor devices may be formed at a relatively low cost. Furthermore, a defect of a semiconductor device may be prevented, and also productivity of a semiconductor manufacturing process may be enhanced.

### BRIEF DESCRIPTION OF THE DRAWINGS

The above and other features and advantages of the present invention will become more apparent by describing in detailed embodiments thereof with reference to the accompanying drawings, in which:

FIGS. 1 to 3 are cross-sectional views illustrating a method of forming a photoresist pattern in accordance with an embodiment of the present invention;

FIGS. 4 to 6 are cross-sectional views illustrating a method of forming a protection layer in a semiconductor device in accordance with an embodiment of the present invention;

FIGS. 7 to 11 are cross-sectional views illustrating a method of forming a protection layer in a semiconductor device in accordance with an embodiment of the present invention;

FIG. 12 is an electron microscopic picture showing a cross section of a photoresist film that was formed using a photoresist composition prepared in Example 1, on which a developing process and a curing process were performed; and

FIG. 13 is an electron microscopic picture showing a cross section of a photoresist film that was formed using a photoresist composition prepared in a Comparative Example, on which a developing process and a curing process were performed.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First Photoresist Composition

A first photoresist composition of the present invention includes a hydrogen-bonding compound and a thermosetting resin.

The hydrogen-bonding compound included in the first photoresist composition may enhance the binding force between molecules of the thermosetting resin. When a photoresist film is formed using a conventional photoresist composition including a thermosetting resin, the photoresist film is partially dissolved in a developing solution so that the loss of the photoresist film is generated in a developing process. However, the hydrogen-bonding compound in the first photoresist composition interacts with a hydrogen atom of the thermosetting resin to form a hydrogen bond. Therefore, attraction forces between molecules of the thermosetting resin may be increased. Furthermore, when a photoresist film is formed using the first photoresist composition of the present invention, and then is soft baked, the hydrogen-bonding compound may migrate to a surface portion of the photoresist film. Accordingly, a relatively large amount of the hydrogen-bonding compound may be positioned at the surface portion of the photoresist film. Thus, the forces of attraction between molecules of the thermosetting resin may become stronger at the surface portion of the photoresist film. This enhanced attraction force at the surface portion of the photoresist film may prevent the photoresist film from being washed away in a developing process. That is, the hydrogen-bonding compound in the first photoresist composition may reduce a solubility of the thermosetting resin relative to a developing solution to prevent loss of the photoresist film in the developing process.

The hydrogen-bonding compound includes a material that forms a hydrogen bond with a hydrogen atom of the thermosetting resin. Examples of the hydrogen-bonding compound that may be used in the first photoresist composition of the present invention may include an oxygen-containing compound, a nitrogen-containing compound, a fluorine-containing compound, etc. These can be used alone or in a mixture thereof. The nitrogen-containing compound may be preferably used as the hydrogen-bonding compound. Here, an oxygen atom of the oxygen-containing compound, a nitrogen atom of the nitrogen-containing compound and a fluorine atom of the fluorine-containing compound have at least one lone electron pair. The lone electron pair of the hydrogen-bonding compound interacts with a hydrogen atom of the thermosetting resin to form a hydrogen bond. Therefore, the force of attraction between molecules of the thermosetting resin may increase.

Examples of the nitrogen-containing compound that may be used in the first photoresist composition of the present invention may include an amine compound, an amide compound, a nitrile compound, etc. These can be used alone or in a mixture thereof. The amine compound may be preferably used as the hydrogen-bonding compound.

Examples of the amine compound that may be used in the first photoresist composition of the present invention may include cyclohexylamine, benzylamine, aniline, p-toluidine, p-chloroaniline, p-nitroaniline, N-methylaniline, diphenylaniline, tripropylamine, N,N-dimethylaniline, diisopropyl phenylamine, etc. These can be used alone or in a mixture thereof.

The first photoresist composition of the present invention includes the thermosetting resin. The thermosetting resin generally has at least three functional groups in one molecule. When the thermosetting resin is heated, the thermosetting resin may be cross-linked to form a three-dimensional network structure. Accordingly, the cured thermosetting resin may not be reshaped again by a mechanical stress, and also may not be dissolved by a solvent.

Examples of the thermosetting resin that may be used in the first photoresist composition of the present invention may include a polyimide resin represented by the following Chemical Formula (1), a polybenzoxazole resin represented by the following Chemical Formula (2), a resol represented by the following Chemical Formula (3), etc. The polyimide resin may be preferably used as the thermosetting resin:

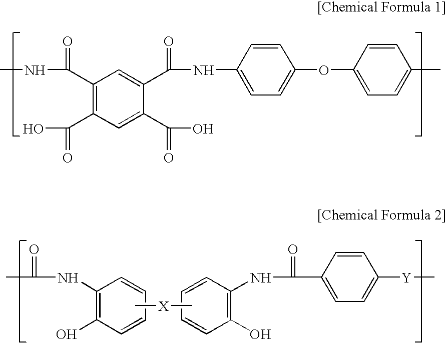

wherein X may represent 2,2-bis(3,4-dicarboxyphenyl)hexafluoropropane dianhydride, biphenyltetracarboxylic dianhydride or 3,3′,4,4′-benzophenonetetracarboxylic dianhydride, and Y may represent p-phenyl diamine, 4,4′-oxydianiline or 2,2′-bis(trifluoromethyl)-4,4′-diaminobiphenyl.

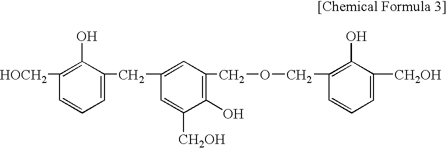

When a weight average molecular weight of the thermosetting resin is less than about 5,000, a photoresist film having a sufficient thickness may not be formed. In addition, when the weight average molecular weight of the thermosetting resin is greater than about 25,000, the first photoresist composition may have an excessively large viscosity so that the photoresist film having a uniform thickness may not be formed. Thus, the thermosetting resin in the first photoresist composition of the present invention may preferably have a weight average molecular weight of from about 5,000 up to about 25,000, and more preferably a weight average molecular weight of from about 10,000 up to about 20,000.

When the content of the hydrogen-bonding compound is greater than about 2 percent by weight of the hydrogen-bonding compound based on a total weight of the photoresist composition, the first photoresist composition may have a reduced resolution so that a desired pattern may not be formed with accuracy. In addition, when the first photoresist composition includes less than about 0.0001 percent by weight, the forces of attraction between molecules of the thermosetting resin may not be sufficiently enhanced, so that the photoresist film that is formed using the first photoresist composition may be washed away in the developing process. Therefore, the first photoresist composition of the present invention may preferably include from about 0.0001 up to about 2 percent by weight of the hydrogen-bonding compound, and more preferably, from about 0.001 up to about 0.5 percent by weight of the hydrogen-bonding compound.

Second Photoresist Composition

A second photoresist composition the present invention includes a hydrogen-bonding compound, a thermosetting resin and an organic solution. The hydrogen-bonding compound and the thermosetting resin are previously described, so detailed descriptions will be omitted.

When the content of the thermosetting resin is less than about 20 percent by weight based on a total weight of the second photoresist composition, a desired pattern may not be formed with accuracy and a photoresist film having a sufficient thickness may not be formed, which is unpreferable. In addition, when the content of the thermosetting resin is greater than about 60 percent by weight, the photoresist film having a uniform thickness may not be unpreferably formed. Thus, the second photoresist composition of the present invention may preferably include about 20 to about 60 percent by weight of the thermosetting resin. As a result, the second photoresist composition of the present invention may preferably include about 0.0001 to about 2 percent by weight of the hydrogen-bonding compound, about 20 to about 60 percent by weight of the thermosetting resin and a remainder of the organic solution.

In an example embodiment of the present invention, the organic solution in the second photoresist composition may include a photoactive compound (PAC) and an organic solvent. The second photoactive compound may have reactivity to a light that is used in an exposure process of a semiconductor manufacturing. Examples of the photoactive compound may include a diazonaphthoquinone (DNQ) compound that is activated by a G-line ray, an I-line ray and the like. The diazonaphthoquinone compound may be represented by the following chemical formula (4) or (5):

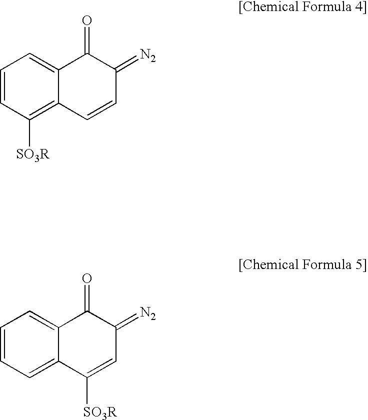

wherein in the Chemical Formulas (4) and (5), R represents an aromatic group. The aromatic group is used as a ballast group. Various types of aromatic groups may be used in accordance with a light absorbance and solubility of the photoactive compound.

The photoactive compound such as a diazonaphthoquinone compound may be combined with a hydroxyl group of the thermosetting resin. The bond between the photoactive compound and the hydroxyl group may be broken by a light such as a G-line ray, an I-line ray, etc. Therefore, when a photoresist film is formed using the second photoresist composition, including the photoactive compound, an exposed portion of the photoresist film may be selectively removed by a developing solution.

When the content of the photoactive compound is less than about 3 percent by weight, based on a total weight of the second photoresist composition, a developing rate may be reduced. In addition, when the second photoresist composition includes greater than about 10 percent by weight of the photoactive compound, a light absorbance may excessively increase so that a bottom portion of the photoresist film may not be sufficiently exposed to a light, and a desired pattern may not be formed clearly. Thus, the second photoresist composition may preferably include from about 3 up to about 10 percent by weight of the photoactive compound. As a result, the second photoresist composition may preferably include from about 0.0001 up to about 2 percent by weight of the hydrogen-bonding compound, from about 20 up to about 60 percent by weight of the thermosetting resin, from about 3 up to about 10 percent by weight of the photoactive compound, and the remainder an organic solvent.

Examples of the organic solvent that may be used in the second photoresist composition may include ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol methyl ether, propylene glycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone, 4-heptanone, γ-butyrolactone, N-methyl-2-pyrrolidone, etc. These can be used alone or in a mixture thereof. Propylene glycol methyl ether acetate, γ-butyrolactone, ethyl lactate or propylene glycol methyl ether may be preferably used as the organic solvent.

In an embodiment of the present invention, the organic solution in the second photoresist composition may include an organic solvent, a photoactive compound and an additive. The organic solvent and the photoactive compound are previously described, so detailed descriptions will be omitted. The additive may enhance adhesion of a photoresist film to an object. Examples of the additive may include a silane-based coupling agent.

Examples of the silane-based coupling agent that may be used as the additive may include aminopropyl triethoxysilane, diethylene triaminopropyl trimethoxysilane, cyclohexylaminopropyl trimethoxysilane, hexanediaminomethyl triethoxysilane, anilinomethyl trimethoxysilane, diethylaminomethyl triethoxysilane, bis(triethoxysilylpropyl) tetrasulfide, mercaptopropyl trimethoxysilane, 3-thiocyantopropyl triethoxysilane, glycidoxypropyl trimethoxysilane, methacryloxypropyl trimethoxysilane, chloropropyl trimethoxysilane, vinyltrimethoxysilane, etc. These can be used alone or in a mixture thereof.

When the content of the additive is less than about 0.001 percent by weight, adhesion of the photoresist film to an underlying layer may not be sufficiently enhanced. In addition, when the second photoresist composition includes greater than about 5 percent by weight of the additive, a predetermined portion of the photoresist film may not be easily removed in a developing process, and an excessive amount of the additive may not be economical. Thus, the second photoresist composition may include from about 0.001 up to about 5 percent by weight of the additive. As a result, the second photoresist composition may preferably include from about 0.0001 up to about 2 percent by weight of the hydrogen-bonding compound, from about 20 up to about 60 percent by weight of the thermosetting resin, from about 3 up to about 10 percent by weight of the photoactive compound, from about 0.001 up to about 5 percent by weight of the additive, and the remainder of the organic solvent.

In an embodiment of the present invention, the organic solution in the second photoresist composition may include an organic solvent, a photoactive compound and a cross-linking agent. The organic solvent and the photoactive compound are previously described, so detailed descriptions will be omitted.

The cross-linking agent may accelerate the cross-linking reaction between molecules of the thermosetting resin. Examples of the cross-linking agent that may be used in the second photoresist composition may include divinylbenzene, phthalic anhydride, tetrahydrophthalic anhydride, nadic methyl anhydride, chloroendic anhydride, phenol-formaldehyde, hexamethylenetetramine, etc. These can be used alone or in a mixture thereof.

When the content of the cross-linking agent is less than about 0.001 percent by weight, the cross-linking reaction between molecules of the thermosetting resin may not be sufficiently generated. In addition, the cross-linking agent of greater than about 10 percent by weight may be uneconomical. Thus, the second photoresist composition may preferably include from about 0.001 up to about 10 percent by weight of the cross-linking agent. As a result, the second photoresist composition may preferably include from about 0.0001 up to about 2 percent by weight of the hydrogen-bonding compound, from about 20 up to about 60 percent by weight of the thermosetting resin, from about 3 up to about 10 percent by weight of the photoactive compound, from about 0.001 up to about 10 percent by weight of the cross-linking agent, and the remainder of the organic solvent.

In an embodiment of the present invention, the organic solution in the second photoresist composition may include an organic solvent, a photoactive compound, an additive and a cross-linking agent. The second photoresist composition may preferably include from about 0.0001 up to about 2 percent by weight of the hydrogen-bonding compound, from about 20 up to about 60 percent by weight of the thermosetting resin, from about 3 up to about 10 percent by weight of the photoactive compound, from about 0.001 up to about 5 percent by weight of the additive, from about 0.001 up to about 10 percent by weight of the cross-linking agent, and the remainder an organic solvent. The organic solvent, the photoactive compound, the additive and the cross-linking agent are previously described, so more detailed descriptions will be omitted.

Method of Forming a Photoresist Pattern

A method of forming a photoresist pattern using the first or the second photoresist composition of the present invention will be fully described hereinafter.

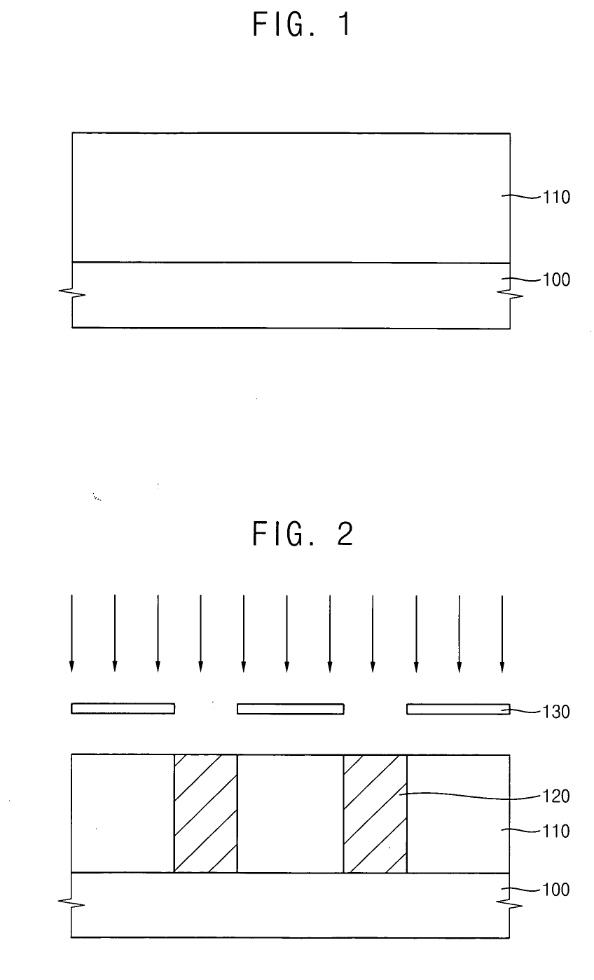

FIGS. 1 to 3 are cross-sectional views illustrating a method of forming a photoresist pattern in accordance with an example embodiment of the present invention. FIG. 1 is a cross-sectional view illustrating a step of forming a photoresist film 110 on an object 100.

Referring to FIG. 1, the photoresist film 110 is formed on an object 100 (e.g., a semiconductor substrate) by coating the object 100 with the first photoresist composition including a hydrogen-bonding compound and a thermosetting resin. The photoresist film 110 may be formed by a spin-coating process. In particular, a chuck on which the object 100 is fixed may rotate at a high speed. While the object 100 rotates, the object 100 may be uniformly coated with the first photoresist composition to form the photoresist film 110.

Examples of the hydrogen-bonding compound that may be used in the method of forming the protection layer may include an oxygen-containing compound, a nitrogen-containing compound, a fluorine-containing compound, etc. These can be used alone or in a mixture thereof. The nitrogen-containing compound such as an amine compound may be preferably used as the hydrogen-bonding compound. In addition, the first photoresist composition may preferably include from about 0.0001 up to about 2 percent by weight of the hydrogen-bonding compound. The thermosetting resin in the first photoresist composition may preferably have a weight average molecular weight of from about 5,000 up to about 25,000. The first photoresist composition is previously described, so more detailed descriptions will be omitted.

In the method of forming the photoresist pattern according to an embodiment of the present invention, the second photoresist composition may be used instead of the first photoresist composition. The second photoresist composition includes a hydrogen-bonding compound, a thermosetting resin and an organic solution. In one embodiment of the present invention, the organic solution may include an organic solvent and a photoactive compound. In another embodiment of the present invention, the organic solution may include the organic solvent, the photoactive compound and an additive. In still another embodiment of the present invention, the organic solution may include the organic solvent, the photoactive compound and a cross-linking agent. The second photoresist composition is previously described, so more detailed descriptions will be omitted.

After a formation of the photoresist film 110, the photoresist film 110 may be softly baked. A soft-baking process may be performed at a temperature substantially lower than that of a subsequent curing process. For example, the soft-baking process is performed at a temperature of from about 50° C. up to about 150° C. The organic solvent in the photoresist film 110 may be evaporated in the soft-baking process. Thus, adhesion between the object 100 and the photoresist film 110 may increase.

Subsequently, the photoresist film 110 is partially removed. A step of partially removing the photoresist film 110 will be fully described hereinafter.

FIG. 2 is a cross-sectional view illustrating a step of exposing the photoresist film 110 to a light.

Referring to FIG. 2, the photoresist film 110 is exposed to the light through a mask 130. In particular, the mask 130 having a predetermined pattern is positioned on a mask stage of an exposure apparatus, and then the mask 130 is arranged over the object 100 having the photoresist film 110 thereon in an alignment process. An illumination light is irradiated onto the mask 130 for a desirable time so that a portion of the photoresist film 110 is selectively reacted with the light through the mask 130.

Examples of the light may include a G-line ray, an I-line ray, a krypton fluoride laser, an argon fluoride laser, an electron beam, an X-ray, etc. The I-line ray or the G-line ray may be preferably used as the light. In an exposure process, an exposed portion 120 of the photoresist film 110 may have a solubility which is substantially different from that of an unexposed portion of the photoresist film 110.

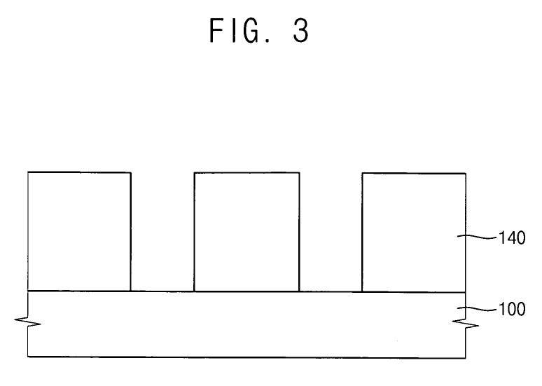

FIG. 3 is a cross-sectional view illustrating a step of forming a photoresist pattern 140 on the object 100.

Referring to FIG. 3, a developing process is performed on the photoresist film 110 to form the photoresist pattern 140. The exposed portion 120 of the photoresist film 110 is removed using a developing solution to form the photoresist pattern 140. For example, the exposed portion 120 of the photoresist film 110 is removed using the developing solution including tetramethylammonium hydroxide (TMAH).

The photoresist pattern 140 may be additionally cured. The thermosetting resin in the photoresist pattern 140 may be cross-linked in a curing process. For example, the curing process may be performed at a temperature of from about 150° C. up to about 350° C.

When the thermosetting resin is cross-linked, water may be generated and evaporated. Thus, the thermosetting resin has different chemical structures before and after the curing process. For example, after the curing process, the polyimide resin has a chemical structure represented by the following Chemical Formula (6), the polybenzoxazole has a chemical structure represented by the following Chemical Formula (7), and the resol has a chemical structure represented by the following Chemical Formula (8):

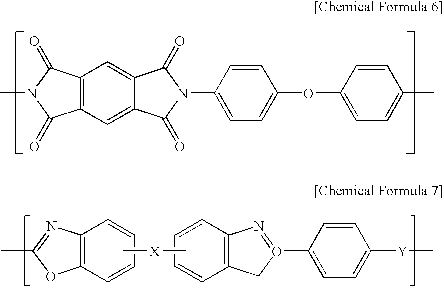

wherein X may represent 2,2-bis(3,4-dicarboxyphenyl)hexafluoropropane dianhydride, biphenyltetracarboxylic dianhydride or 3,3′,4,4′-benzophenonetetracarboxylic dianhydride, and Y may represent p-phenyl diamine, 4,4′-oxydianiline or 2,2′-bis(trifluoromethyl)-4,4′-diaminobiphenyl.

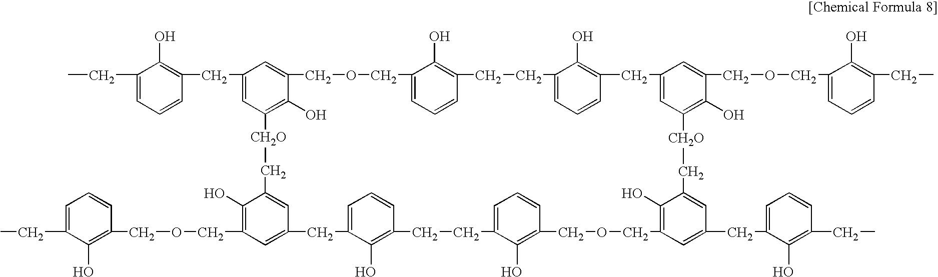

The object 100 including the photoresist pattern 140 located thereon may be cleaned, and then other conventional processes may be additionally performed.

Method of Forming a Protection Layer in a Semiconductor Device

A method of forming a protection layer in a semiconductor device using the first or the second photoresist composition of the present invention will be fully described hereinafter.

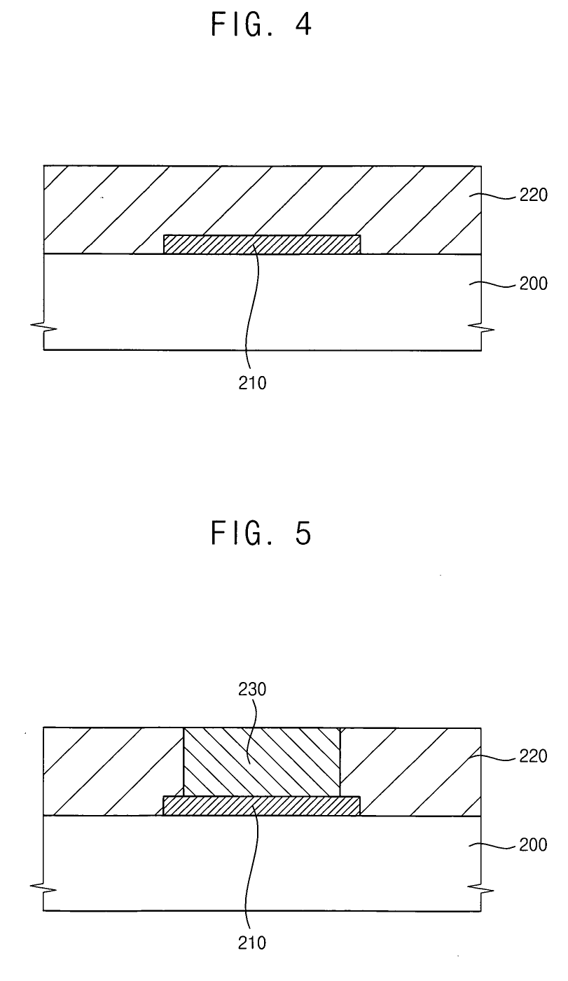

FIGS. 4 to 6 are cross-sectional views illustrating a method of forming a protection layer in a semiconductor device in accordance with an example embodiment of the present invention.

FIG. 4 is a cross-sectional view illustrating a step of forming a preliminary protection layer 220 on a substrate 200 including a pad 210 thereon.

Referring to FIG. 4, the preliminary protection layer 220 is formed on the substrate 200 including the pad 210 located thereon. The preliminary protection layer 220 may be formed by coating the substrate 200 with the first photoresist composition including a hydrogen-bonding compound and a thermosetting resin. The pad 210 may comprise a metal such as aluminum, copper and the like.

In an embodiment of the present invention, an additional protection layer (not shown) may be formed on the substrate 200, including the pad 210 located thereon, before the formation of the preliminary protection layer 220. Here, the preliminary protection layer 220 may be formed on the additional protection layer. The additional protection layer may be formed using an oxide such as silicon oxide, or a nitride such as silicon nitride.

In an example embodiment of the present invention, the additional protection layer may be partially removed to form an opening (not shown) exposing the pad 210, and then the preliminary protection layer 220 may be formed on the additional protection layer including the opening.

Examples of the hydrogen-bonding compound that may be used in the method of forming the protection layer in the semiconductor device may include an oxygen-containing compound, a nitrogen-containing compound, a fluorine-containing compound, etc. These can be used alone or in a mixture thereof. The nitrogen-containing compound such as an amine compound may be preferably used as the hydrogen-bonding compound. In addition, the first photoresist composition may preferably include from about 0.0001 up to about 2 percent by weight of the hydrogen-bonding compound. The thermosetting resin in the first photoresist composition may preferably have a weight average molecular weight of from about 5,000 up to about 25,000. The first photoresist composition is previously described, so more detailed descriptions will be omitted.

In the method of forming the protection layer in the semiconductor device according to an embodiment of the present invention, the second photoresist composition may be used instead of the first photoresist composition. The second photoresist composition includes a hydrogen-bonding compound, a thermosetting resin and an organic solution. In one embodiment of the present invention, the organic solution may include an organic solvent and a photoactive compound. In another example embodiment of the present invention, the organic solution may include the organic solvent, the photoactive compound and an additive. In still another embodiment of the present invention, the organic solution may include the organic solvent, the photoactive compound and a cross-linking agent. The second photoresist composition is previously described, so more detailed descriptions will be omitted.

FIG. 5 is a cross-sectional view illustrating a step of exposing the preliminary protection layer 220 to a light.

Referring to FIG. 5, a portion of the preliminary protection layer 220 is exposed to a light. Examples of the light that may be used in an exposure process may include an I-line ray, a G-line ray and the like. An exposed portion 230 of the preliminary protection layer 220 may have solubility substantially different from that of an unexposed portion of the preliminary protection layer 220 in the exposure process.

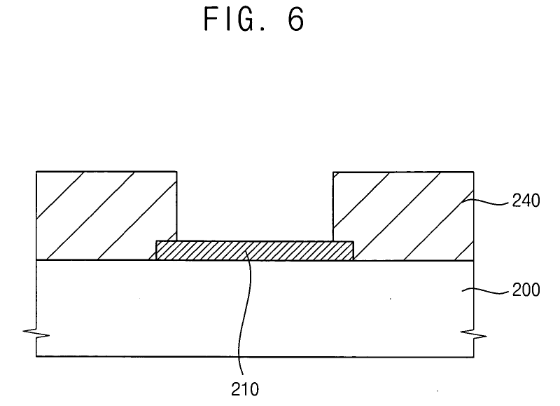

FIG. 6 is a cross-sectional view illustrating a step of forming a protection layer 240 on the substrate 200.

Referring to FIG. 6, the preliminary protection layer 220 is developed to form the protection layer 240 exposing the pad 210. The protection layer 240 is formed on the substrate 200 by removing the exposed portion 230 of the preliminary protection layer 220 using a developing solution. For example, the exposed portion 230 of the preliminary protection layer 220 is removed using a developing solution including tetramethylammonium hydroxide (TMAH) and the like.

In an example embodiment of the present invention, the protection layer 240 may be additionally cured. The thermosetting resin in the protection layer 240 may be cross-linked in a curing process. For example, the curing process may be performed at a temperature of from about 150° C. up to about 350° C.

In an example embodiment of the present invention, the additional protection layer that may be formed on the substrate 200 including the pad 210 before a formation of the preliminary protection layer 220, may be partially removed using the protection layer 240 as a mask to expose the pad 210.

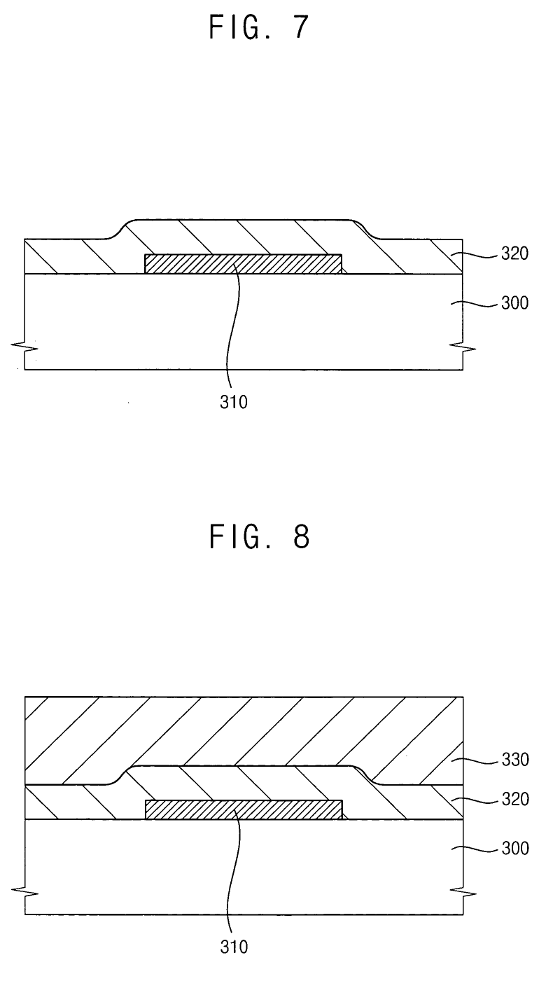

FIGS. 7 to 11 are cross-sectional views illustrating a method of forming a protection layer in a semiconductor device in accordance with an example embodiment of the present invention.

FIG. 7 is a cross-sectional view illustrating a step of forming a first protection layer 320 on a semiconductor substrate 300 including a bonding pad 310 thereon.

Referring to FIG. 7, the first protection layer 320 is formed on the semiconductor substrate 300 including the bonding pad 310 thereon. The bonding pad 310 may comprise a metal such as aluminum, copper, etc. The bonding pad 310 may be connected to a lid frame by a wire in a subsequent process. The first protection layer 320 may be formed of an oxide such as silicon oxide, or a nitride such as silicon nitride. For example, the first protection layer 320 including a nitride is formed by a plasma-enhanced chemical-vapor deposition (PECVD), or the first protection layer 320 including an oxide is formed by a low-pressure chemical-vapor deposition (LPCVD).

FIG. 8 is a cross-sectional view illustrating a step of forming a second protection layer 330 on the first protection layer 320.

Referring to FIG. 8, the second protection layer 330 is formed on the first protection layer 320 by coating the first protection layer 320 with the first photoresist composition including a hydrogen-bonding compound and a thermosetting resin.

Examples of the hydrogen-bonding compound that may be used in the method of forming the protection layer in the semiconductor device may include an oxygen-containing compound, a nitrogen-containing compound, a fluorine-containing compound, etc. These can be used alone or in a mixture thereof. The nitrogen-containing compound such as an amine compound may be preferably used as the hydrogen-bonding compound. In addition, the first photoresist composition may preferably include from about 0.0001 up to about 2 percent by weight of the hydrogen-bonding compound. The thermosetting resin in the first photoresist composition may preferably have a weight average molecular weight of from about 5,000 up to about 25,000. The first photoresist composition is previously described, so more detailed descriptions will be omitted.

In the method of forming the protection layer in the semiconductor device according to an embodiment of the present invention, the second photoresist composition may be used instead of the first photoresist composition. The second photoresist composition includes a hydrogen-bonding compound, a thermosetting resin and an organic solution. In one embodiment of the present invention, the organic solution may include an organic solvent and a photoactive compound. In another example embodiment of the present invention, the organic solution may include the organic solvent, the photoactive compound and an additive. In still another embodiment of the present invention, the organic solution may include the organic solvent, the photoactive compound and a cross-linking agent. The second photoresist composition is previously described, so more detailed descriptions will be omitted.

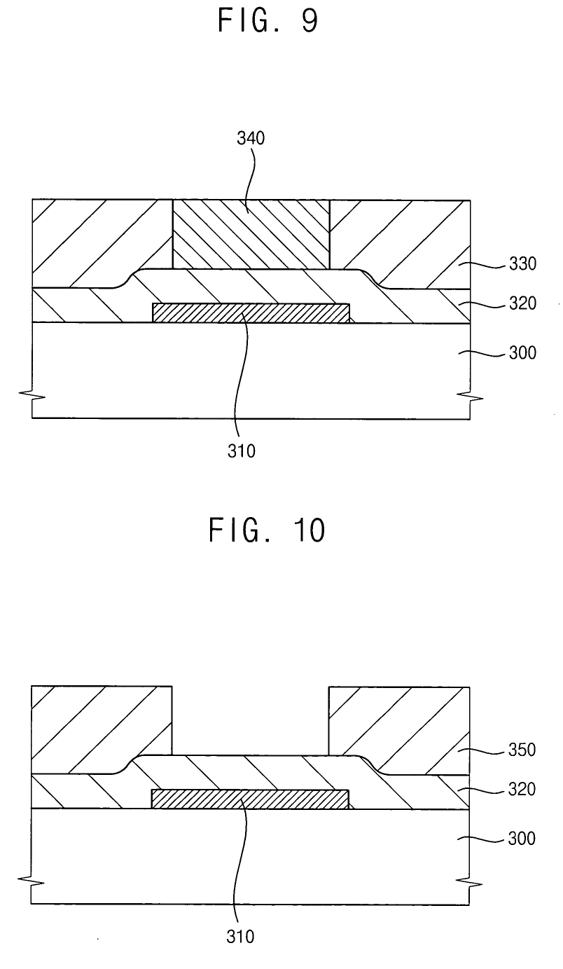

FIG. 9 is a cross-sectional view illustrating a step of exposing the second protection layer 330 to a light.

Referring to FIG. 9, a portion of the second protection layer 330 is exposed to a light through a mask. Examples of the light that may be used in an exposure process may include an I-line ray, a G-line ray and the like. An exposed portion 340 of the second protection layer 330 may have solubility substantially different from that of an unexposed portion of the second protection layer 330 in the exposure process. The exposed portion 340 of the second protection layer 330 will be removed to expose a predetermined portion of the first protection layer 320 over the bonding pad 310 in a subsequent process.

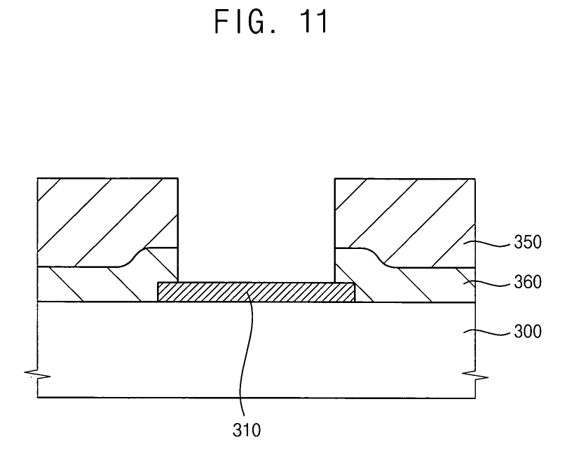

In an embodiment of the present invention, a reticle of the mask for forming the exposed portion 340 of the second protection layer 330 may be advantageously designed to have a width substantially narrower than that of the bonding pad 310 by from about 0.5 μm up to about 2 μm, because a second protection layer pattern 350 (see FIG. 10) may shrink by from about 0.5 μm up to about 2 μm in a subsequent curing process. Thus, shrinkage of the second protection layer pattern 350 in the subsequent curing process may be complemented.

FIG. 10 is a cross-sectional view illustrating a step of forming the second protection layer pattern 350 on the first protection layer 320.

Referring to FIG. 10, the second protection layer 330 is developed to form the second protection layer pattern 350 exposing a predetermined portion of the first protection layer 320. The second protection layer pattern 350 is formed on the first protection layer 320 by removing the exposed portion 340 of the second protection layer 330 using a developing solution. For example, the exposed portion 340 of the second protection layer 330 is removed using a developing solution including tetramethylammonium hydroxide (TMAH) and the like.

In an embodiment of the present invention, the second protection layer pattern 350 may be additionally cured. The second protection layer pattern 350 may shrink in a curing process so that a thickness and a width of the second protection layer may be reduced. For example, the width of the second protection layer pattern 350 decreases by from about 0.5 μm up to about 2 μm.

FIG. 11 is a cross-sectional view illustrating a step of forming a first protection layer pattern 360 on the semiconductor substrate 300.

Referring to FIG. 11, a predetermined portion of the first protection layer 320 is removed using the second protection layer pattern 350 as a mask to form the first protection layer pattern 360 exposing the bonding pad 310. In particular, the first protection layer 320 is etched using the second protection layer pattern 350 as an etching mask. The first protection layer 320 may be etched by a dry etching process using plasma. As the first protection layer pattern 360 is formed on the semiconductor substrate 300, a protection layer in a semiconductor device that includes the first protection layer pattern 360 and the second protection layer pattern 350 is finished.

The photoresist composition of the present invention will be further described through Examples and a Comparative Example, hereinafter.

Preparation of a Photoresist Composition

### EXAMPLE 1

A photoresist composition was prepared by mixing about 31 percent by weight of a polyimide resin, about 7 percent by weight of diazonaphthoquinone (DNQ), about 1 percent by weight of tetrahydrophthalic anhydride, about 0.2 percent by weight of diisopropyl phenylamine and a remainder of an organic solvent, based on a total weight of the photoresist composition. The organic solvent was prepared by mixing γ-butyrolactone and ethyl lactate in a weight ratio of about 40:60.

### EXAMPLES 2 AND 3

Photoresist compositions were prepared by processes substantially identical to those of Example 1 except for the content of the diisopropyl phenylamine. Components and contents of the photoresist compositions according to the Examples are shown in the following Table 1.

### EXAMPLE 4

A photoresist composition was prepared by mixing about 31 percent by weight of a polyimide resin, about 7 percent by weight of diazonaphthoquinone (DNQ), about 3 percent by weight of aminopropyl triethoxysilane, about 0.2 percent by weight of diisopropyl phenylamine and a remainder of an organic solvent, based on a total weight of the photoresist composition. The organic solvent was prepared by mixing γ-butyrolactone and ethyl lactate in a weight ratio of about 40:60.

### EXAMPLE 5

A photoresist composition was prepared by mixing about 31 percent by weight of a polyimide resin, about 7 percent by weight of diazonaphthoquinone (DNQ), about 0.2 percent by weight of diisopropyl phenylamine and a remainder of an organic solvent, based on a total weight of the photoresist composition. The organic solvent was prepared by mixing γ-butyrolactone and ethyl lactate in a weight ratio of about 40:60.

### COMPARATIVE EXAMPLE

A photoresist composition was prepared by mixing about 31 percent by weight of a polyimide resin, about 1 percent by weight of tetrahydrophthalic anhydride, about 7 percent by weight of diazonaphthoquinone (DNQ), and the remainder of an organic solvent, based on a total weight of the photoresist composition. The organic solvent was prepared by mixing γ-butyrolactone and ethyl lactate in a weight ratio of about 40:60.

TABLE 1

| | | | | | Diisopropyl |
|---|---|---|---|---|---|
| | Polyimide | DNQ | Additive/Cross linking | | Phenylamine |
| | Resin [wt %] | [wt %] | Agent [wt %] | | [wt %] |
| Example 1 | 31 | 7 | Cross linking | 1 | 0.2 |
| | | | Agent | | |
| Example 2 | 31 | 7 | Cross linking | 1 | 0.27 |
| | | | Agent | | |
| Example 3 | 31 | 7 | Cross linking | 1 | 0.36 |
| | | | Agent | | |
| Example 4 | 31 | 7 | Silane based | 3 | 0.2 |
| | | | Coupling Agent | | |
| Example 5 | 31 | 7 | — | | 0.2 |
| Compara- | 31 | 7 | Cross linking | 1 | — |
| tive | | | Agent | | |
| Example | | | | | |

Evaluation of Damage to a Photoresist Film

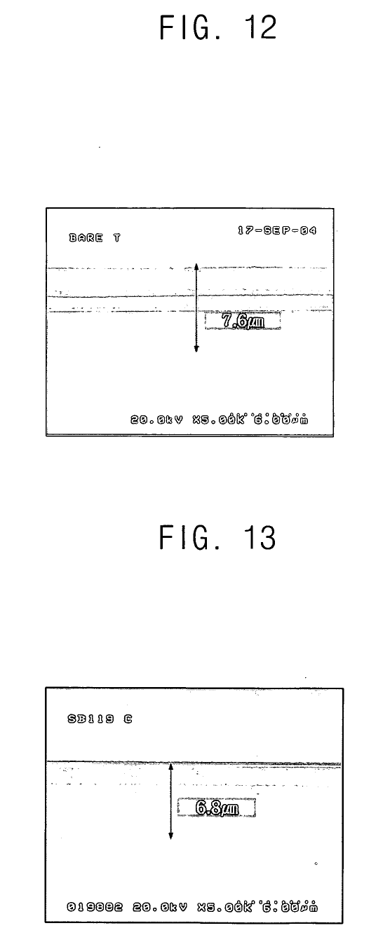

Photoresist films were formed using the photoresist compositions prepared in Examples and a Comparative Example. After developing processes were performed on the photoresist films, damages to the photoresist films were evaluated. The evaluation results are shown in the following Table 2 and FIGS. 12 and 13. In particular, the photoresist films were formed by coating bare wafers with the photoresist compositions prepared in Examples 1 to 3 and the Comparative Example respectively. The photoresist films were softly baked. For the photoresist composition prepared in the Comparative Example, three photoresist films were formed on three bare wafers. A first photoresist film formed using the photoresist composition prepared in the Comparative Example was softly baked at a temperature of about 122° C. for about 200 seconds. The first photoresist film had a thickness of about 13.47 μm. Second and third photoresist films formed using the photoresist composition prepared in the Comparative Example were softly baked at a temperature of about 119° C. for about 240 seconds. The second and third photoresist films had thicknesses of about 13.42 μm and about 12.00 μm, respectively. The photoresist films formed using the photoresist compositions prepared in Examples 1 to 3 were softly baked at a temperature of about 119° C. for about 240 seconds. The photoresist films formed using the photoresist compositions prepared in Examples 1 to 3 had a thickness of about 12.0 μm. The photoresist films were developed using an aqueous solution including about 2.38 percent by weight of tetramethylammonium hydroxide (TMAH). After the developing process, the photoresist films were cured at a temperature of about 300° C.

Damage or loss of the photoresist film was evaluated by measuring a thickness difference before and after the developing process. The photoresist film that was softly baked had a first thickness (T₁) before the developing process. After the developing process, the photoresist film had a second thickness (T₂). The thickness difference (ΔT) was calculated by subtracting the second thickness (T₂) from the first thickness (T₁). Furthermore, the photoresist film had a third thickness (T₃) after the curing process. The evaluation results are shown in the following Table 2.

TABLE 2

| | | | Thickness | |
|---|---|---|---|---|
| | 1st Thickness | 2nd Thickness | Difference | 3rd Thickness |
| | (T₁) [μm] | (T₂) [μm] | (ΔT) [μm] | (T₃) [μm] |
| Example 1 | 12.0 | 10.1 | 1.9 | 7.6 |
| Example 2 | 12.0 | 10.5 | 1.5 | 7.9 |
| Example 3 | 12.0 | 10.6 | 1.4 | 7.9 |
| Comparative Example | 13.47 | 10.54 | 2.93 | 7.95 |
| (1st Photoresist Film) | | | | |
| Comparative Example | 13.42 | 10.47 | 2.95 | 7.84 |
| (2nd Photoresist Film) | | | | |
| Comparative Example | 12.0 | 9.1 | 2.9 | 6.8 |
| (3rd Photoresist Film) | | | | |

FIG. 12 is a scanning electron microscopic (SEM) picture showing a cross section of the photoresist film formed using the photoresist composition prepared in Example 1, on which the developing process and the curing process are performed. FIG. 13 is a SEM picture showing a cross section of the third photoresist film formed using the photoresist composition prepared in the Comparative Example, on which the developing process and the curing process are performed.

Referring to Table 2 and FIGS. 12 and 13, it may be noted that the photoresist films formed using the photoresist compositions including the hydrogen-bonding compound have thickness differences (ΔT) substantially smaller than those of the first to third photoresist films formed using the photoresist composition not including the hydrogen-bonding compound. In particular, the first photoresist film has a thickness decrease of about 21.75 percent, the second photoresist film has a thickness decrease of about 21.98 percent, and the third photoresist film has a thickness decrease of about 24.17 percent. However, the photoresist film formed using the photoresist composition prepared in Example 1 has a thickness decrease of about 15.83 percent, the photoresist film formed using the photoresist composition prepared in Example 2 has a thickness decrease of about 12.5 percent, and the photoresist film formed using the photoresist composition prepared in Example 3 has a thickness decrease of about 11.67 percent. Therefore, it may be confirmed that the hydrogen-bonding compound in the photoresist composition of the present invention enhances the attraction force between molecules of the thermosetting resin so that damage or loss of the photoresist film may be reduced in the developing process.

From the thickness differences of Examples 1 to 3, it may be confirmed that as the content of the hydrogen-bonding compound increases, the photoresist film may be less damaged. However, an excessive amount of the hydrogen-bonding compound may obstruct a development of the photoresist film so that a desired photoresist pattern may not be formed with accuracy. Therefore, a preferable content of the hydrogen-bonding compound in the photoresist composition may be less than or equal to about 2 percent by weight based on a total weight of the photoresist composition. When photoresist films are formed using the photoresist composition prepared in Examples 4 and 5, the photoresist films may be also less damaged in the same manner as those of Examples 1 to 3.

According to the present invention, a protection layer may be formed using the photoresist composition including the hydrogen-bonding compound and the thermosetting resin. The hydrogen-bonding compound may interact with a hydrogen atom of the thermosetting resin to form a hydrogen bond, so that an attraction force between molecules of the thermosetting resin may be enhanced. Thus, damage or loss of the protection layer may be prevented in the developing process, and the protection layer that effectively passivates underlying semiconductor devices may be formed at a relatively low cost. Furthermore, a defect of a semiconductor device may be prevented, and also productivity of a semiconductor manufacturing process may be enhanced.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A photoresist composition comprising a hydrogen-bonding compound and a thermosetting resin.

2. The photoresist composition of claim 1, wherein the hydrogen-bonding compound is selected from the group consisting of an oxygen-containing compound, a nitrogen-containing compound, a fluorine-containing compound, and combinations thereof.

3. The photoresist composition of claim 2, wherein the nitrogen-containing compound is selected from the group consisting of an amine compound, an amide compound, a nitrile compound, and combinations thereof.

4. The photoresist composition of claim 3, wherein the nitrogen-containing compound comprises the amine compound.

5. The photoresist composition of claim 4, wherein the amine compound is selected from the group consisting of cyclohexylamine, benzylamine, aniline, p-toluidine, p-chloroaniline, p-nitroaniline, N-methylaniline, diphenylaniline, tripropylamine, N,N-dimethylaniline, diisopropyl phenylamine, and combinations thereof.

6. The photoresist composition of claim 1, wherein the thermosetting resin comprises a polyimide resin represented by the following Chemical Formula 1, a polybenzoxazole resin represented by the following Chemical Formula 2, or a resol represented by the following Chemical Formula 3: 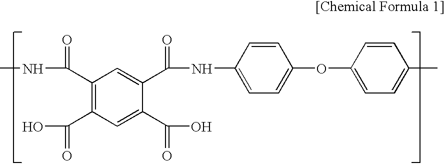 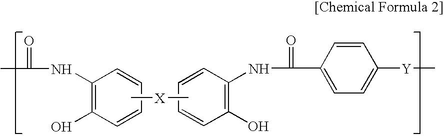
wherein X represents 2,2-bis(3,4-dicarboxyphenyl)hexafluoropropane dianhydride, biphenyltetracarboxylic dianhydride or 3,3′,4,4′-benzophenonetetracarboxylic dianhydride, and Y represents p-phenyl diamine, 4,4′-oxydianiline or 2,2′-bis(trifluoromethyl)-4,4′-diaminobiphenyl.

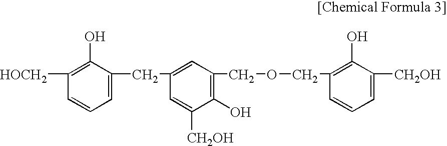

7. The photoresist composition of claim 1, wherein the thermosetting resin has a weight average molecular weight of from about 5,000 up to about 25,000.

8. The photoresist composition of claim 1, wherein the thermosetting resin has a weight average molecular weight of from about 10,000 up to about 20,000.

9. The photoresist composition of claim 1, wherein the photoresist composition comprises from about 0.0001 up to about 2 percent by weight of the hydrogen-bonding compound, based on a total weight of the photoresist composition.

10. The photoresist composition of claim 9, wherein the photoresist composition comprises from about 0.001 up to about 0.5 percent by weight of the hydrogen-bonding compound, based on a total weight of the photoresist composition.

11. A photoresist composition comprising a hydrogen-bonding compound, a thermosetting resin and an organic solution.

12. The photoresist composition of claim 11, wherein the photoresist composition comprises:
from about 0.0001 up to about 2 percent by weight of the hydrogen-bonding compound;
from about 20 up to about 60 percent by weight of the thermosetting resin; and
a remainder of the organic solution.

13. The photoresist composition of claim 11, wherein the organic solution comprises an organic solvent and a photoactive compound.

14. The photoresist composition of claim 13, wherein the photoresist composition comprises:
from about 0.0001 up to about 2 percent by weight of the hydrogen-bonding compound;
from about 20 up to about 60 percent by weight of the thermosetting resin;
from about 3 up to about 10 percent by weight of the photoactive compound; and
a remainder of the organic solvent.

15. The photoresist composition of claim 13, wherein the organic solvent is selected from the group consisting of ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol methyl ether, propylene glycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone, 4-heptanone, γ-butyrolactone, N-methyl-2-pyrrolidone, and combinations thereof.

16. The photoresist composition of claim 13, wherein the photoactive compound comprises a diazonaphthoquinone (DNQ) compound represented by the following Chemical Formula 4 or 5: 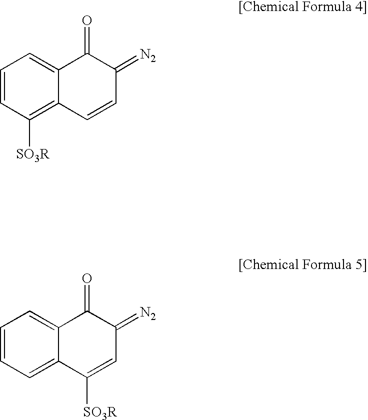
wherein R represents an aromatic group.

17. The photoresist composition of claim 11, wherein the organic solution comprises an organic solvent, a photoactive compound and an additive.

18. The photoresist composition of claim 17, wherein the photoresist composition comprises:
from about 0.0001 up to about 2 percent by weight of the hydrogen-bonding compound;
from about 20 up to about 60 percent by weight of the thermosetting resin;
from about 3 up to about 10 percent by weight of the photoactive compound;
from about 0.001 up to about 5 percent by weight of the additive; and
a remainder of an organic solvent.

19. The photoresist composition of claim 17, wherein the additive comprises a silane-based coupling agent.

20. The photoresist composition of claim 11, wherein the organic solution comprises an organic solvent, a photoactive compound and a cross-linking agent.

21. The photoresist composition of claim 20, wherein the photoresist composition comprises:
from about 0.0001 up to about 2 percent by weight of the hydrogen-bonding compound;
from about 20 up to about 60 percent by weight of the thermosetting resin;
from about 3 up to about 10 percent by weight of the photoactive compound;
from about 0.001 up to about 10 percent by weight of the cross-linking agent; and
a remainder of the organic solvent.

22. The photoresist composition of claim 20, wherein the cross-linking agent is selected from the group consisting of divinylbenzene, phthalic anhydride, tetrahydrophthalic anhydride, nadic methyl anhydride, chloroendic anhydride, phenol-formaldehyde, hexamethylenetetramine, and combinations thereof.

23. A method of forming a photoresist pattern comprising:
forming a photoresist film on an object by coating the object with a photoresist composition including a hydrogen-bonding compound and a thermosetting resin; and
partially removing the photoresist film to form said photoresist pattern.

24. The method of claim 23, wherein the hydrogen-bonding compound is selected from the group consisting of an oxygen-containing compound, a nitrogen-containing compound, a fluorine-containing compound, and combinations thereof.

25. The method of claim 24, wherein the nitrogen-containing compound comprises an amine compound.

26. The method of claim 25, wherein the amine compound is selected from the group consisting of cyclohexylamine, benzylamine, aniline, p-toluidine, p-chloroaniline, p-nitroaniline, N-methylaniline, diphenylaniline, tripropylamine, N,N-dimethylaniline, diisopropyl phenylamine, and combinations thereof.

27. The method of claim 23, wherein partially removing the photoresist film comprises:
exposing a portion of the photoresist film to a light; and
developing the photoresist film.

28. The method of claim 27, wherein the photoresist film is exposed to the light comprising a G-line ray, an I-line ray, a krypton fluoride laser, an argon fluoride laser, an electron beam or an X-ray.

29. The method of claim 28, wherein the photoresist film is exposed to the light comprising an I-line or a G-line ray.

30. The method of claim 27, wherein the photoresist film is developed using tetramethylammonium hydroxide.

31. The method of claim 23, further comprising curing the photoresist film after partially removing the photoresist film.

32. The method of claim 31, wherein the thermosetting resin is cross-linked in a curing of the photoresist film.

33. The method of claim 31, wherein the photoresist film is cured at a temperature of from about 150° C. up to about 350° C.

34. A method of forming a protection layer in a semiconductor device comprising:
forming a preliminary protection layer on a substrate including a pad by coating said substrate with a photoresist composition including a hydrogen-bonding compound and a thermosetting resin;
exposing a portion of the preliminary protection layer to a light; and
developing the preliminary protection layer to form a protection layer exposing the pad.

35. The method of claim 34, wherein the hydrogen-bonding compound is selected from the group consisting of an oxygen-containing compound, a nitrogen-containing compound, a fluorine-containing compound, and combinations thereof.

36. The method of claim 35, wherein the nitrogen-containing compound comprises an amine compound.

37. The method of claim 36, wherein the amine compound is selected from the group consisting of cyclohexylamine, benzylamine, aniline, p-toluidine, p-chloroaniline, p-nitroaniline, N-methylaniline, diphenylaniline, tripropylamine, N,N-dimethylaniline, diisopropyl phenylamine, and combinations thereof.

38. The method of claim 34, wherein before forming the preliminary protection layer, forming an additional protection layer on the substrate including the pad.

39. The method of claim 38, wherein the additional protection layer comprises oxide or nitride.

40. The method of claim 39, wherein the additional protection layer comprises silicon oxide.

41. The method of claim 38, further comprising partially removing the additional protection layer to expose the pad.

42. The method of claim 38, further comprising partially removing the additional protection layer using the protection layer as a mask to expose the pad.

43. The method of claim 34, further comprising curing the protection layer.

44. A method of forming a protection layer in a semiconductor device comprising:
forming a first protection layer on a semiconductor substrate including a bonding pad;
forming a second protection layer on the first protection layer by coating with a photoresist composition including a hydrogen-bonding compound and a thermosetting resin;
exposing a portion of the second protection layer to a light;
developing the second protection layer to form a second protection layer pattern exposing a predetermined portion of the first protection layer; and
partially removing the first protection layer using the second protection layer as a mask to form a first protection layer pattern exposing the bonding pad.
